(19) United States
(12) Patent Application Publication
(10) Pub. No.: US 2014/0094278 A1
(43) Pub. Date: Apr. 3, 2014

(54) LOAN TRANSACTIONS IN A GAMING ENVIRONMENT

(71) Applicant: WMS GAMING, INC., Waukegan, IL (US)

(72) Inventors: Thomas Abouchar, Atlanta, GA (US); Jamie W. Vann, Chicago, IL (US); Andrew Christian Guinn, Chicago, IL (US); Daniel Louie, Chicago, IL (US)

(73) Assignee: WMS GAMING, INC., Waukegan, IL (US)

(21) Appl. No.: 13/786,619

(22) Filed: Mar. 6, 2013

Related U.S. Application Data
(60) Provisional application No. 61/706,948, filed on Sep. 28, 2012.

(51) Int. Cl. G07F 17/32

(52) U.S. Cl. CPC G07F 17/3244
USPC 463/25

(57) ABSTRACT

Loaning in a gaming environment may be managed by determining a loan value associated with a first player account, determining a transfer of the loan value from the first player account to a second player account, and determining a wager of the loan value from the second player account in the primary game. A loan win amount attributable to a winning outcome of the primary game when the loan value is used may be determined, and respective shares of the loan win amount may be allocated to the first and second player accounts.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates generally to gaming apparatus and methods and, more particularly, to systems and methods for managing loaning between players in a gaming environment.

### BACKGROUND OF THE DISCLOSURE

Wagering game machines, such as slot machines, video poker machines, and the like, have been a cornerstone of the gaming industry for several years. Traditionally, wagering game machines have been confined to physical structures, such as land- or water-based casinos (e.g., resort casinos, road-side casinos, casino boats, etc.). Casinos are located in specific geographical locations that are authorized to present wagering games to casino patrons. The proliferation of interest and use of a global public network (such as the Internet), however, potentially expands access to wagering games to locations outside of the physical casino structures. Consequently, any individual with a personal computing device (e.g., a personal computer, a laptop, a personal digital assistant, a mobile phone, etc.) can connect to the Internet and process wagering games. Consequently, some wagering game manufacturers have created wagering games that can be processed by personal computing devices and offered via online casino websites (“online casinos”). Several challenges, however, confront the development and operation of online casinos. For example, online casinos have struggled to provide the excitement and entertainment found in real world casino environments. Some online casinos have found it difficult to enforce cross-jurisdictional restrictions and requirements. Further, some online casinos have struggled to adapt the online gaming industry to a traditionally non-wagering game business environment. Consequently, wagering game manufacturers, casino operators, and online game providers are confronted with various challenges to making the online gaming industry appealing and profitable.

### SUMMARY OF THE DISCLOSURE

According to one aspect of the disclosure, a computer-implemented method of managing a loan transaction in a wagering game may determining at least one loan condition associated with a first loan value in a first player account. In response to determining an acceptance of the at least one loan condition by a second player account, the method may further include transferring the first loan value from the first player account to the second player account. Further, in response to determining that the at least one loan condition is present, the method may include determining a wager of the first loan value from the second player account in the wagering game. A loan win amount may be determined that is attributable to an outcome of the wager of the first loan value, and first and second player portions of the loan win amount may be determined.

According to another aspect of the disclosure, a gaming system includes a processor, a memory in communication with the processor, a display, and an input/output circuit, where the processor is physically configured according to computer executable instructions for managing loaning in a primary game, the computer executable instructions comprising instructions for determining at least one loan condition associated with a first loan value in a first player account; in response to determining an acceptance of the at least one loan condition by a second player account, transferring the first loan value from the first player account to the second player account; in response to determining that the at least one loan condition is present, determining a wager of the first loan value from the second player account in the wagering game; determining a loan win amount attributable to an outcome of the wager of the first loan value; determining a first player portion of the loan win amount; and determining a second player portion of the loan win amount.

According to yet another aspect of the present disclosure, a tangible machine-readable storage media includes instructions which, when executed by one or more processors, cause the one or more processors to perform operations that include the above methods.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic illustration of a gaming system according to an embodiment of the present disclosure.

FIG. 2 is a schematic illustration of an online gaming server usable in the gaming system of FIG. 1.

FIG. 3 is a schematic illustration of a computational device usable in the gaming system of FIG. 1.

FIG. 4a is a perspective view of a free-standing gaming machine usable in the gaming system of FIG. 1.

FIG. 4b is a schematic illustration of architecture for the gaming machine of FIG. 4a.

FIG. 5 is a perspective view of a handheld gaming machine usable in the gaming system of FIG. 1.

FIG. 6a is an image of an exemplary registration interface for a gaming service displayed on an output device of a client, according to an embodiment of the present disclosure.

FIG. 6b is an image of an exemplary gameplay interface for a gaming service displayed on an output device of a client, according to an embodiment of the present disclosure.

FIG. 7 is an illustration of a manner of managing a loan transaction in a wagering game.

While the claimed subject matter is susceptible to various modifications and alternative forms, specific embodiments have been shown by way of example in the drawings and will be described in detail herein. It should be understood, however, that the claimed subject matter is not intended to be limited to the particular forms disclosed. Rather, the intention is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill In some embodiments, the wagering game may involve wagers of real money, as found with typical land-based or on-line casino game formats. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

### Overall Network

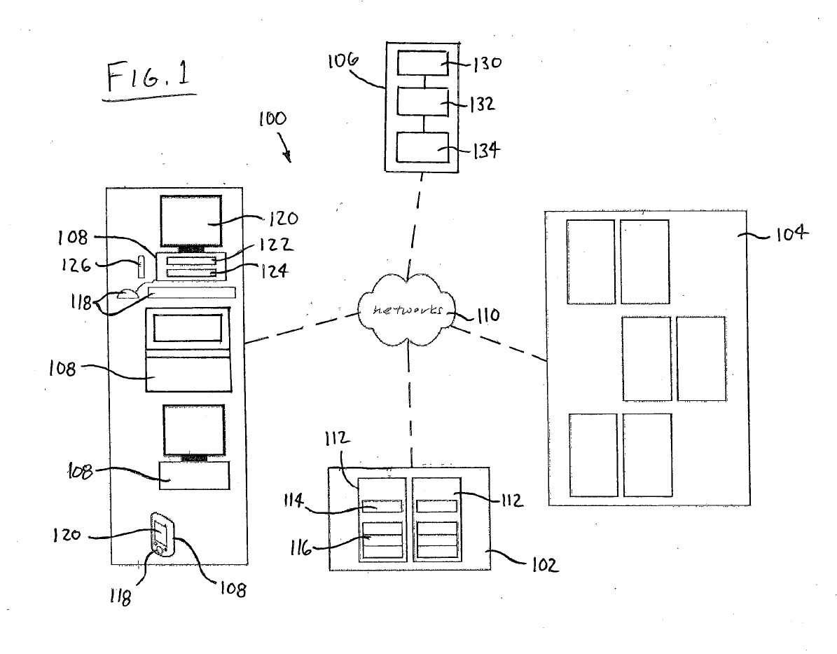

Referring to FIG. 1, one exemplary embodiment of a gaming system 100 is provided. In general, the gaming system 100 may be used to manage and/or facilitate certain interactions between gaming service providers, players or registrants of games provided by the gaming service providers, as well as social and/or virtual communities with which the players or registrants may be affiliated, associated and/or registered. As shown, the gaming system 100 includes at least one or more gaming servers 102, one or more community servers 104, one or more account servers 106, and one or more client devices 108, as well as one or more networks 110 electronically communicating information between each of the gaming servers 102, community servers 104, account servers 106, and clients 108. More specifically, the one or more networks 110 enable users or registrants at the client devices 108 to access gaming services from the gaming servers 102, social networks and/or virtual communities from the community servers 104, and account services from the account servers 106.

While each component of the gaming system 100 is shown as a separate and distinct element connected via a communications network 110, some of functions discussed herein as being performed by one component may be performed by other components. For example, the gaming servers 102 may also be configured to gather and store biometric data, record and store online gaming activity, transfer shared files between player accounts, etc. The components shown may all be contained in one device, but some, or all, may be included in, or performed by multiple devices, or other configurations not shown.

Furthermore, the gaming system 100 may be implemented as software, hardware, any combination thereof, or other forms not listed. For example, any of the network components (e.g., the gaming servers 102, community servers 104, account servers 106, client devices 108, etc.) may include hardware and machine-readable media including instructions for performing the operations described herein. Machine-readable media includes any mechanism that provides (i.e., stores and/or transmits) information in a form readable by a machine (e.g., a gaming machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

Thus, in some embodiments, the clients 108 may be dedicated gaming devices such as a gaming device provided in a casino. The gaming device may execute the gaming computer code locally or the gaming device may be thought of as a node on a network where one or more servers (which may be local or remote) may execute code and the video signal may be communicated to the gaming device. In other embodiments, the gaming device may be a computing device in a user's home such as a personal computer. The processor in the computing device may be physically configured to execute the code on the personal computer. In other embodiments, the computing device may be thought of as a node on a network where a server is physically configured according to the gaming computing instructions. In yet another embodiment, the gaming device may be a portable computing device. The portable computing device may be physically configured to execute the gaming code or the portable computing device may be in communication with a server that executes some or all of the gaming code and communicates images to be displayed. In all the embodiments, the gaming device may communicate with a central authority that may track game play, awards, likes, dislikes, etc., assuming sufficient permission is obtained. The communication may be wired or wireless and the communication may be secured in a manner to ensure the integrity of the game and the privacy of the player information. In addition, the game may operate on a variety of platforms, from an operating system on a PC to a social media application on a portable computing device platform, to a gaming console platform.

### Gaming Servers

As shown in FIG. 1, the gaming system 100 includes one or more gaming servers 102 which are managed or operated by gaming service providers and configured to enable registered players or registrants to participate in any one or more of a variety of gaming services over the one or more networks 110 provided. Accordingly, the gaming servers 102 may be configured to manage a plurality of databases including, for example, a registrant database and a gaming service database, among other things. Moreover, as is generally held in the art, each gaming server 102 may include one or more computational devices 112 having at least one processor 114 and at least one memory 116 for storing instructions configured to cause the one or more processors 114 of the gaming server 102 to perform one or more preprogrammed functions or operations.

The one or more gaming servers may be located proximately to or remotely from the clients 108. When located proximately, such as at a land-based casino location, the one or more gaming servers 102 may be considered to be part of a casino server. Alternatively, when located remotely, the one or more gaming servers 102 may be considered to be an on-line gaming server. Furthermore, the gaming system may include both one or more casino servers and one or more on-line gaming servers.

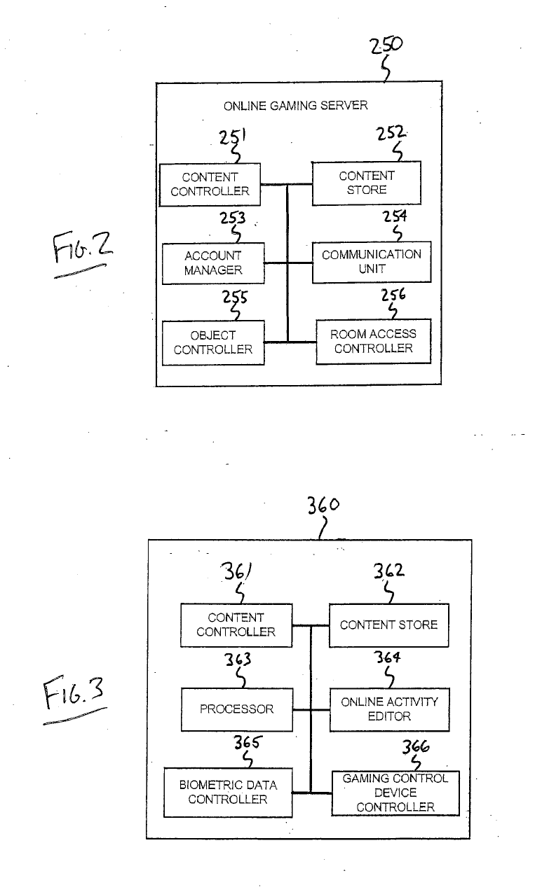

An example of an on-line gaming server 250 is schematically illustrated in greater detail in FIG. 2. The online gaming server 250 may be configured to control wagering game content, provide random numbers, and communicate wagering game information, account information, and other information to and from the clients 108. The online gaming server 250 may include a content controller 251 configured to manage and control content for the presentation of content on the clients 108. For example, the content controller 251 may generate game results, including win amounts, for games played on the clients 108, and communicate the game results to the clients 108. The content controller 251 may also generate random numbers and provide them to the client 108 so that the clients 108 may generate game results.

The online gaming server 250 may also include a content store 252 configured to contain content to present on the clients 108. The online gaming server 250 may also include an account manager 253 configured to control information related to player accounts. For example, the content controller 251 may communicate wager amounts, game results amounts (e.g., win amounts), award game amounts, etc., to the account server 106. The online gaming server 250 may also include a communication unit 254 configured to communicate information to the clients 108 and to communicate with other systems, devices and networks. For example, the communication unit 254 may track and communicate with community wagering game servers, account servers, community servers, social networking servers, file sharing servers, etc. The online gaming server 250 may also include an object controller 255 configured to control positions, movements, actions, functions, etc. of online gaming objects. The online gaming server 250 may also include a room access controller 256 configured to control access to online gaming venue rooms, including security and access levels based on player settings, player status, etc.

### Community Servers/Networks

The community servers 104 of FIG. 1 may be similarly managed or operated by social networks and include virtual communities, public forums, blogs, and the like. Such community servers 104 typically include databases for not only managing the web-based interfaces associated with one or more online communities, but also for managing databases of information pertaining to registrants or members as well as corresponding member profiles, registration information, user preferences, and the like. As with the gaming servers 102, services of the community servers 104 are accessible to registrants via client devices 108 and through the one or more networks 110 interconnecting the client 108 to the community servers 104. Specifically, the network 110 may take the form of a local area network (LAN), a wireless cellular data network, a wide area network (WAN) such as the internet, or any other suitable network or combination of networks enabling local and/or remote communications between the gaming servers 102, community servers 104, account servers 106, and clients 108.

### Account Servers

The account server 106 may be configured to control user related accounts accessible via wagering game networks, which may include land-based or on-line casino networks and social networks. The account server 106 may store and track player information, such as identifying information (e.g., avatars, screen name, account identification numbers, etc.) or other information like financial account information, social contact information, etc. The account server 106 may contain accounts for social contacts referenced by the player account. The account server 106 may also provide auditing capabilities, according to regulatory rules, and track the performance of players, machines, and servers.

As schematically illustrated in FIG. 1, the account server 106 may include an account controller 130 configured to control information for a player's account, an account store 132 configured to store information for a player's account, and a player preferences settings 134 configured to store settings associated with actions, skins, behaviors, multi-media files, music, and other information with a player account's indicated expressions of emotion, and/or a system imposed expression of an emotion, for an avatar or other object within the online gaming venue. The player preferences settings 134 may communicate information to the object controller 255 to apply the information stored in the settings to an avatar object associated with the player account.

### Client Devices

As depicted in the embodiment of FIG. 1, the client devices or clients 108 may take any one of a plurality of forms including a mobile device, a cellular phone, a smartphone, a tablet device, a laptop computer, a desktop computer, a stationary gaming machine, a portable gaming machine, or any other computational device having at least one input device 118 and at least one output device 120. The input device 118 may include any one or more of a mouse, a keypad, a keyboard, a touchpad, a touchscreen, a microphone, a camera, and any other device enabling the registered player to input information. The output device 120 may include any one or more of a monitor, a display screen, a touchscreen, a speaker, or any other output device enabling a gaming service to be presented to the player. The client device 108 also includes one or more processors 122 and at least one memory 124 for storing instructions configured to cause the processor 122 to, among other things, facilitate and/or provide an interface through which a player may participate in one or more gaming services sourced by the gaming servers 102 using the input devices 118 and output devices 120. Correspondingly, the client device 108 additionally includes at least one communication device 126, such as a modem, a receiver, a transmitter, a transceiver, a network card, an Ethernet card, or any other communication device having wired and/or wireless connectivity with the gaming servers 102 through the one or more networks 110.

The clients 108 may communicate with external systems (in a wired or wireless manner) such that each client 108 operates as a “thin client,” having relatively less functionality, a “thick client,” having relatively more functionality, or through any range of functionality therebetween (e.g., a “rich client”). When configured as a “thin client,” the client 108 may operate primarily as a display device to display the results of gaming outcomes processed externally, for example, on a server, which may be an external computing device or a “cloud” of computing devices that communicate and work together. In this “thin client” configuration, the external server executes game code and determines game outcomes (e.g., with a random number generator), while a controller on board the client 108 processes display information to be displayed on the display(s) 120.

In an alternative “rich client” configuration, the external server may determine game outcomes while the controller on board the client 108 executes game code and processes display information to be displayed on the display(s) 120. In yet another alternative “thick client” configuration, a controller on board the client 108 executes game code, determines game outcomes, and processes display information to be displayed on the display(s) 120. Numerous alternative configurations are possible such that the aforementioned and other functions may be performed onboard or external to the client 108 as may be necessary for particular applications. It should be understood that the clients 108 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

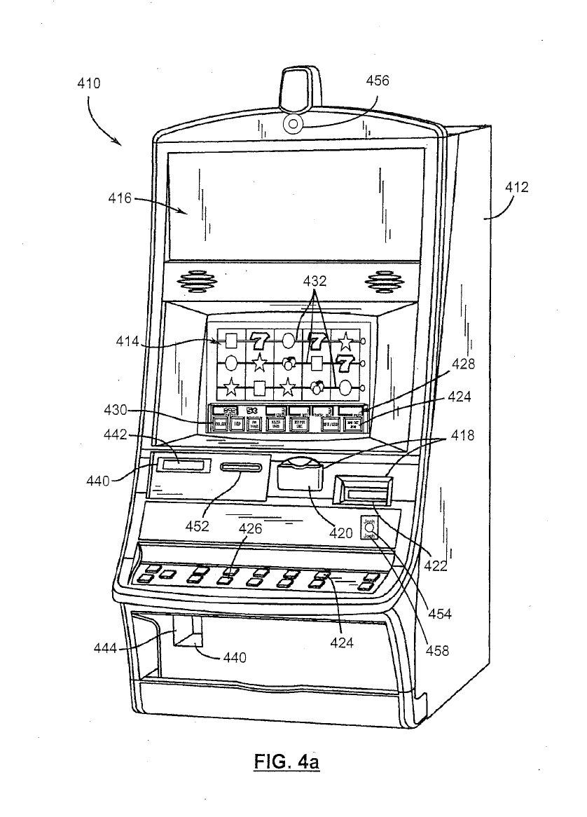

An embodiment of a client 108 is schematically illustrated as a computational device 360 in FIG. 3. The computational device 360 may be configured to present wagering games and receive and transmit information to control and present online wagering games. The computational device 360 may include a content controller 361 configured to manage and control content and presentation of online gaming venue content on the computational device 360. The computational device 360 may also include a content store 362 configured to contain content to present on the computer system 360. The computational device 360 may also include a processor 363 configured to process wagering game content, present online wagering game objects, control gaming devices, etc.

The computational device 360 may include an online activity editor 364 configured to record, modify, and share recorded online gaming activity. The online activity editor 364 may be configured to add comments, text, pictures and other multi-media modifications to the recorded online gaming activity files. The online activity editor 364 may share the recorded online gaming activity with other player accounts. The computational device 360 may also include a biometric data controller 365 configured to detect biometric data from one or more sensors and equipment attached to the computational device and transfer the data to the object controller to express one or more indications of emotions by a player account. The computer system 360 may also include a gaming control device controller 366 configured to detect and control devices, including a gaming pad, custom player control devices, login devices, etc. The gaming pad, for example, may be configured to move an avatar within the online gaming venue in a very fluid motion, much more fluidly than possible with a standard keyboard.

### Casino Gaming Machine

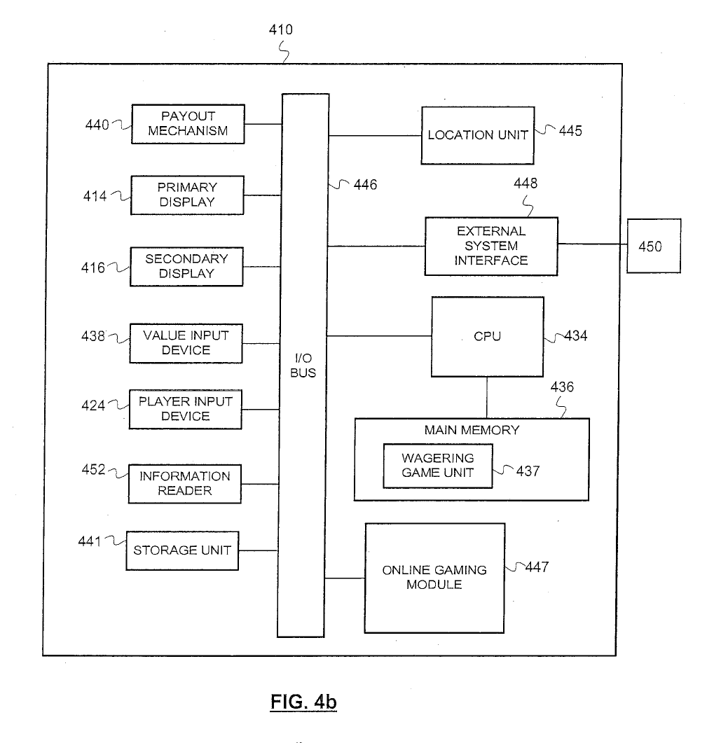

One type of client 108 may be a casino gaming machine 410 configured for use in a gaming establishment such as a casino, as illustrated in FIGS. 4a and 4b. The gaming machine 410 may be any type of gaming machine and may have varying structures and methods of operation. For example, the gaming machine 410 may be an electromechanical gaming machine configured to play mechanical slots, or it may be an electronic gaming machine configured to play a video casino game, such as slots, keno, poker, blackjack, roulette, etc.

The casino gaming machine 410 may include a housing 412 and may include input devices, including a value input device 418 and a player input device 424. For output, the gaming machine 410 may include a primary display 414 for displaying information about the wagering game. The primary display 414 may also display information about an award wagering game and a progressive wagering game. The gaming machine 410 may also include a secondary display 416 for displaying game events, game outcomes, and/or signage information. While these typical components found in the gaming machine 410 are described below, it should be understood that numerous other elements may exist and may be used in any number of combinations to create various forms of a gaming machine 410.

The value input device 418 may be provided in many forms, individually or in combination, and is preferably located on the front of the housing 412. The value input device 418 may receive currency and/or credits that may be inserted by a player. The value input device 418 may include a coin acceptor 420 for receiving coin currency (see FIG. 4a). Alternatively, or in addition, the value input device 418 may include a bill acceptor 422 for receiving paper currency. Furthermore, the value input device 418 may include a ticket reader, or barcode scanner, for reading information stored on a credit ticket, a card, or other tangible portable credit storage device. The credit ticket or card may also authorize access to a central account, which can transfer play credits to the casino gaming machine 410.

The player input device 424 may include a plurality of push buttons 426 on a button panel for operating the gaming machine 410. In addition, or alternatively, the player input device 424 may include a touch screen 428 mounted by adhesive, tape, or the like over the primary display 414 and/or secondary display 416. The touch screen 428 may include soft touch keys 430 denoted by graphics on the underlying primary display 414 and may be used to operate the gaming machine 410. The touch screen 428 may provide players with an alternative method of input. A player may enable a desired function either by touching the touch screen 428 at an appropriate touch key 430 or by pressing an appropriate push button 426 on the button panel. The touch keys 430 may be used to implement the same functions as push buttons 426. Alternatively, the push buttons 426 may provide inputs for one aspect of operating the game, while the touch keys 430 may allow for input needed for another aspect of the game. In some embodiments, a physical player sensor 456 may also be included. The physical player sensor 456 may be a camera or a biometric sensor or a motion detecting device. The physical player sensor 456 may be used to provide inputs to the game, such as images, selection motions, biometric data and other physical information.

The various components of the gaming machine 410 may be connected directly to, or contained within, the housing 412, as shown in FIG. 4a, or may be located outboard of the housing 412 and connected to the housing 412 via a variety of different wired or wireless connection methods. Thus, the gaming machine 410 may include these components whether housed in the housing 412, or outboard of the housing 412 and connected remotely.

The operation of the basic wagering game may be displayed to the player on the primary display 414. The primary display 414 may also display the award game associated with the basic wagering game. The primary display 414 may take the form of a cathode ray tube (CRT), a high resolution LCD, a plasma display, an LED, or any other type of display suitable for use in the gaming machine 410. As shown, the primary display 414 may include the touch screen 428 overlaying the entire display (or a portion thereof) to allow players to make game-related selections. Alternatively, the primary display 414 of the gaming machine 410 may include a number of mechanical reels to display the outcome in visual association with at least one payline 432. In the illustrated embodiment, the gaming machine 410 is an “upright” version in which the primary display 414 is oriented vertically relative to the player. Alternatively, the gaming machine may be a “slant-top” version in which the primary display 414 may be slanted at about a thirty-degree angle toward the player of the gaming machine 410.

A player may begin play of the basic wagering game by making a wager via the value input device 418 of the gaming machine 410. The value wagered may have a real money value or may be a virtual value that is not redeemable in cash. A player may select play by using the player input device 424, via the buttons 426 or the touch screen keys 430. The basic game may include of a plurality of symbols arranged in an array, and may include at least one payline 432 that indicates one or more outcomes of the basic game. Such outcomes may be randomly selected in response to the wagering input by the player. At least one of the plurality of randomly-selected outcomes may be a start-award outcome, which may include any variations of symbols or symbol combinations triggering a award game.

In some embodiments, the gaming machine 410 may also include a player information reader 452 that allows for identification of a player by reading a card 454 with player information 458 indicating his or her true identity. The player information reader 452 is shown in FIG. 4a as a card reader, but may take on many forms including a ticket reader, bar code scanner, RFID transceiver or computer readable storage medium interface. Currently, identification 458 may be generally used by casinos for rewarding certain players with complimentary services or special offers. For example, a player may be enrolled in the gaming establishment's loyalty club and may be awarded certain complimentary services as that player collects points in his or her player-tracking account. The player may insert his or her card 454 into the player information reader 452, which allows the casino's computers to register that player's wagering at the gaming machine 410. The gaming machine 410 may use the secondary display 416 or other dedicated player-tracking display for providing the player with information about his or her account or other player-specific information. Also, in some embodiments, the information reader 452 may be used to recall or restore game assets that the player achieved and saved during a previous game session either in the gaming establishment or on a separate computing device at a different location.

Turning now to FIG. 4b, the various components of the gaming machine 410 may be controlled by a central processing unit (CPU) 434, also referred to herein as a controller or processor (such as a microcontroller or microprocessor). The controller 434 may include any suitable processor, such as an Intel® Pentium processor, Intel® Core 2 Duo processor, AMD Opteron™ processor, or UltraSPARC processor. To provide gaming functions, the controller 434 may execute (or be physically configured according to) one or more game programs stored in a computer readable storage medium, in the form of a main memory 436. The main memory 436 may include a volatile memory (e.g., a random-access memory (RAM)) and a non-volatile memory (e.g., an EEPROM). The main memory 436 may include multiple RAM and multiple program memories. The main memory 436 may further include a wagering game unit 437. In some embodiments, the wagering game unit 437 may present wagering games having a casino game format, such as video poker, video black jack, video slots, video lottery, reel slots, etc., in whole or in part. Alternatively, the wagering games may be in a casual or social game format, as described in greater detail below.

The controller 434 may perform the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It may be appreciated that the controller 434 may include one or more microprocessors, including but not limited to a master processor, a slave processor, and a secondary or parallel processor.

The controller 434 may also be coupled to a value input device 438. The value input device 438 may signal the processor that money and/or credits have been input via the value input device 418. These components may be located within the housing 412 of the gaming machine 410 or, as explained above, may be located outboard of the housing 412 and connected to the remainder of the components of the gaming machine 410 via a variety of different wired or wireless connection methods.

As seen in FIG. 4b, the controller 434 also may be connected to, and may control, the primary display 414, the player input device 424, a payout mechanism 440, and a storage unit 441. The payout mechanism 440 may be operable in response to instructions from the controller 434 to award a payout to the player in response to certain winning outcomes that might occur in the basic game or the award game(s). The payout may be provided in the form of points, bills, tickets, coupons, cards, etc. For example, in FIG. 4a, the payout mechanism 440 may include both a ticket printer 442 and a coin outlet 444. However, any of a variety of payout mechanisms 440 well known in the art may be implemented, including cards, coins, tickets, smartcards, cash, etc. The payout amounts distributed by the payout mechanism 440 may be determined by one or more pay tables stored in the main memory 436.

An input/output (“I/O”) bus 446 may provide communications between the controller 434 and the peripheral components of the gaming machine. The I/O bus 446 may include any suitable bus technologies, such as an AGTL+frontside bus and a PCI backside bus. More specifically, the controller 434 may control and receive inputs from the peripheral components of the gaming machine 410 through the I/O bus 446. The I/O bus 446 also may be connected to an external system interface 448, which in turn is connected to external systems 450. The external systems 450 may include a gaming network, other gaming machines, a gaming server, communications hardware, or a variety of other interfaced systems or components. The controller 434 may communicate with the external systems 450 via the external system interface 448 and a communication path (e.g., serial, parallel, IR, RC, 10bT, etc.) The external system interface 448 may include logic for exchanging information over wired and wireless networks (e.g., 802.11g transceiver, Bluetooth transceiver, Ethernet transceiver, etc.). Although the I/O bus 446 and external system interface 448 may be illustrated as single blocks, it should be appreciated that each may include a number of different types of I/O circuits.

The I/O bus 446 further may be connected to a location unit 445. The location unit 445 may create player information that indicates the wagering game machine's location/movements in a casino. In some embodiments, the location unit 445 includes a global positioning system (GPS) receiver that can determine the wagering game machine's location using GPS satellites. In other embodiments, the location unit 445 may include a radio frequency identification (RFID) tag that can determine the wagering game machine's location using RFID readers positioned throughout a casino. Some embodiments can use GPS receivers and RFID tags in combination, while other embodiments may use other suitable methods for determining the wagering game machine's location. Although not shown in FIG. 4b, in some embodiments the location unit 445 is not connected to the I/O bus 446.

In some embodiments, the wagering game machine 410 may include an online gaming module 447. The online gaming module 447 may process communications, commands, or other information, where the processing may control and present online wagering games.

Controller 434, as used herein, may include any combination of hardware, software, and/or firmware, that may be disposed or resident inside and/or outside of the gaming machine 410, which may communicate with and/or control the transfer of data between the gaming machine 410 and a bus, another computer, processor, or device and/or a service and/or a network. The controller 434 may include one or more controllers or processors. In FIG. 4b, the controller 434 in the gaming machine 410 is depicted as comprising a CPU, but the controller 434 may alternatively include a CPU in combination with other components, such as the I/O bus 446, the external system interface 448, and the main memory 436. The controller 434 may reside partially or entirely inside or outside of the machine 410. The control system for a mobile gaming machine (disclosed below) may be similar to the control system for the free standing gaming machine 410 except that the functionality of the respective on-board controllers may vary.

### Mobile Gaming Machine

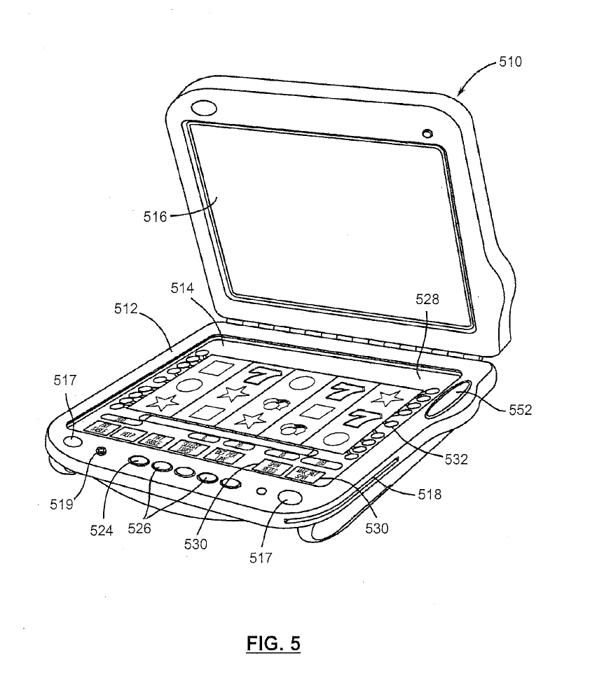

Another type of client 108 may be a handheld or mobile gaming machine 510, illustrated in FIG. 5. Like the free standing casino gaming machine 410, the mobile gaming machine 510 may be an electronic gaming machine configured to play a casino game such as, but not limited to, slots, keno, poker, blackjack, and roulette. The mobile gaming machine 510 may include a housing or casing 512 and may include input devices, including a value input device 518 and a player input device 524. For output, the mobile gaming machine 510 may include, but is not limited to, a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the mobile gaming machine 510 may include a secondary display 516 that is rotatable relative to the primary display 514. The optional secondary display 516 may be fixed, movable, and/or detachable/attachable relative to the primary display 514. Either the primary display 514 and/or secondary display 516 may be configured to display any aspect of a wagering game, an award game, a progressive wagering game, a group game, a shared-experience game or event, a game event, a game outcome, scrolling information, text messaging, an emails, an alert or announcement, broadcast information, subscription information, and mobile gaming machine status.

The player-accessible value input device 518 may include, for example, a slot located on the front, side, or top of the casing 512 configured to receive credit from a stored-value card (e.g., casino card, smart card, debit card, credit card, etc.) inserted by a player. In another aspect, the player-accessible value input device 518 may include a sensor (e.g., an RF sensor) configured to sense a signal (e.g., an RF signal) output by a transmitter (e.g., an RF transmitter) carried by a player. The player-accessible value input device 518 may also or alternatively include a ticket reader, or barcode scanner, for reading information stored on a credit ticket, a card, or other tangible portable credit or funds storage device. The credit ticket or card may also authorize access to a central account, which may transfer money or play credits to the mobile gaming machine 510.

Still other player-accessible value input devices 518 may require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player may be permitted to access a player's account. As one potential optional security feature, the mobile gaming machine 510 may be configured to permit a player to only access an account the player has specifically set up for the mobile gaming machine 510. Other conventional security features may also be utilized to, for example, prevent unauthorized access to a player's account, to minimize an impact of any unauthorized access to a player's account, or to prevent unauthorized access to any personal information or funds temporarily stored on the mobile gaming machine 510.

The player-accessible value input device 518 may itself include or utilize a biometric player information reader which permits the player to access available funds on a player's account, either alone or in combination with another of the aforementioned player-accessible value input devices 518. In an embodiment wherein the player-accessible value input device 518 include a biometric player information reader, transactions such as an input of value to the mobile device, a transfer of value from one player account or source to an account associated with the mobile gaming machine 510, or the execution of another transaction, for example, may all be authorized by a biometric reading, which may include a plurality of biometric readings, from the biometric device.

Alternatively, to enhance security, a transaction may be optionally enabled only by a two-step process in which a secondary source confirms the identity indicated by a primary source. For example, a player-accessible value input device 518 may include a biometric player information reader which may require a confirmatory entry from another biometric player information reader 552, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) may be utilized to provide enhanced security prior to the electronic transfer of any funds. In another aspect, the value input device 518 may be provided remotely from the mobile gaming machine 510.

The player input device 524 may include a plurality of push buttons on a button panel for operating the mobile gaming machine 510. In addition, or alternatively, the player input device 524 may include a touch screen 528 mounted to a primary display 514 and/or secondary display 516. In one aspect, the touch screen 528 may be matched to a display screen having one or more selectable touch keys 530 selectable by a user's touching of the associated area of the screen using a finger or a tool, such as a stylus pointer. A player may enable a desired function either by touching the touch screen 528 at an appropriate touch key 530 or by pressing an appropriate push button 526 on the button panel. The touch keys 530 may be used to implement the same functions as push buttons 526. Alternatively, the push buttons may provide inputs for one aspect of the operating the game, while the touch keys 530 may allow for input needed for another aspect of the game. The various components of the mobile gaming machine 510 may be connected directly to, or contained within, the casing 512, as seen in FIG. 5, or may be located outboard of the casing 512 and connected to the casing 512 via a variety of hardwired (tethered) or wireless connection methods. Thus, the mobile gaming machine 510 may include a single unit or a plurality of interconnected parts (e.g., wireless connections) which may be arranged to suit a player's preferences.

The operation of the basic wagering game on the mobile gaming machine 510 may be displayed to the player on the primary display 514. The primary display 514 may also display the award game associated with the basic wagering game. The primary display 514 may take the form of a high resolution LCD, a plasma display, a LED, or any other type of display suitable for use in the mobile gaming machine 510. In some embodiments, the gaming machine 510 may be provided as a portable phone, portable gaming console, or other specific or multi-purpose hand-held device, in which case the primary display 514 may be the display provided with such a device. The size of the primary display 514 may vary from, for example, about a 2-3″ display to a 15″ or 17″ display. In at least some embodiments, the primary display 514 may be a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 514 and/or secondary display 516 may have a 16:9 aspect ratio or other aspect ratio (e.g., 4:3) and the aspect ratio may be modified depending on the game and use of the device. The primary display 514 and/or secondary display 516 may also each have different resolutions, different color schemes, and different aspect ratios.

As with the free standing casino gaming machine 410, a player may begin play of the basic wagering game on the mobile gaming machine 510 by making a wager (e.g., via the value input device 518 or an assignment of credits stored on the mobile gaming machine 510 via the touch screen keys 530, player input device 524, or buttons 526) on the mobile gaming machine 510. In at least some aspects, the basic game may include a plurality of symbols arranged in an array, and includes at least one payline 532 that indicates one or more outcomes of the basic game. Such outcomes may be randomly selected in response to the wagering input by the player. At least one of the plurality of randomly selected outcomes may be a start-award outcome, which can include any variations of symbols or symbol combinations triggering a award game.

In some embodiments, the player-accessible value input device 518 of the mobile gaming machine 510 may double as a player information reader 552 that allows for identification of a player by reading a card 354 (FIG. 3) with information indicating the player's identity (e.g., reading a player's credit card, player ID card, smart card, etc.). The player information reader 552 may alternatively or also include a bar code scanner, RFID transceiver or computer readable storage medium interface. In one embodiment, the player information reader 552, shown by way of example in FIG. 5, may include a biometric sensing device.

### Gaming System Security

Security features are advantageously utilized where the gaming machines 410, 510 communicate wirelessly with external systems, such as through wireless local area network (WLAN) technologies, wireless personal area networks (WPAN) technologies, wireless metropolitan area network (WMAN) technologies, wireless wide area network (WWAN) technologies, or other wireless network technologies implemented in accord with related standards or protocols (e.g., the Institute of Electrical and Electronics Engineers (IEEE) 802.11 family of WLAN standards, IEEE 802.11i, IEEE 802.11r (under development), IEEE 802.11w (under development), IEEE 802.15.1 (Bluetooth), IEEE 802.12.3, etc.). For example, a WLAN in accord with at least some aspects of the present concepts may include a robust security network (RSN), a wireless security network that allows the creation of robust security network associations (RSNA) using one or more cryptographic techniques, which provides one system to avoid security vulnerabilities associated with IEEE 802.11 (the Wired Equivalent Privacy (WEP) protocol). Constituent components of the RSN may include, for example, stations (STA) (e.g., wireless endpoint devices such as laptops, wireless mobile devices, cellular phones, mobile gaming machine 510, etc.), access points (AP) (e.g., a network device or devices that allow(s) an STA to communicate wirelessly and to connect to a(nother) network, such as a communication device associated with I/O circuit(s) 448), and authentication servers (AS) (e.g., an external system 450), which provide authentication services to STAs. Information regarding security features for wireless networks may be found, for example, in the National Institute of Standards and Technology (NIST), Technology Administration U.S. Department of Commerce, Special Publication (SP) 800-97, ESTABLISHING WIRELESS ROBUST SECURITY NETWORKS: A GUIDE TO IEEE 802.11, and SP 800-48, WIRELESS NETWORK SECURITY: 802.11, BLUETOOTH AND HANDHELD DEVICES, both of which are incorporated herein by reference in their entirety.

### Client Interface—Registration

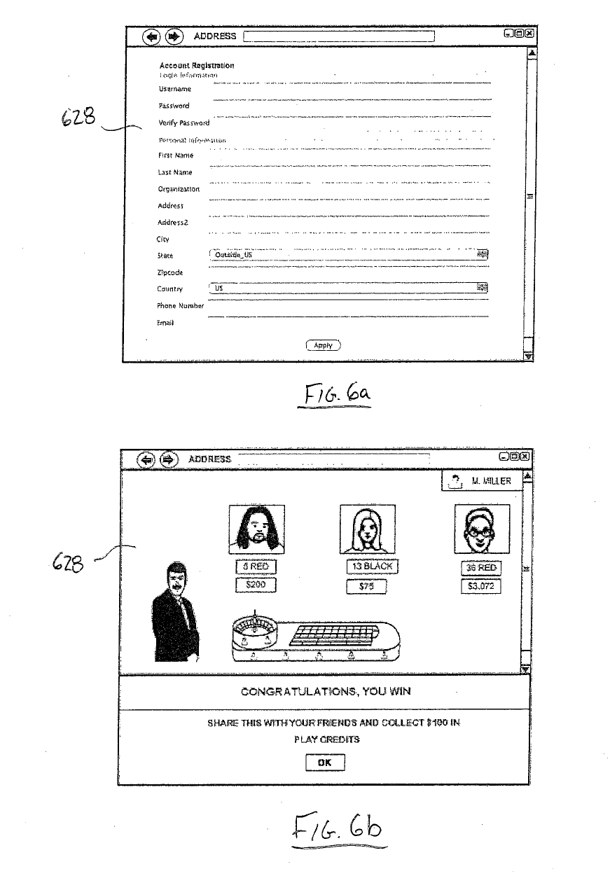

Among other things, the clients 108 may be configured to communicate with the gaming servers 102 to retrieve gaming service data, display gaming service data, operate a gaming service on the client devices 108, and communicate any relevant input provided by the player and received through the one or more input devices 118 back to the gaming servers 102. Gaming service data may be initially retrieved from the gaming servers 102 by request of the player at the client 108. Specifically, the player can initiate the request by navigating a web browser, or the like, within the client device 108 to one or more network or internet addresses associated with and/or managed by the gaming servers 102. Upon receiving the request, the gaming servers 102 communicate gaming service data associated with the desired gaming service through the network 110 to be downloaded, installed and executed on the client device 108. The gaming service data may contain information which, once downloaded and installed within the client device 108, creates an interface 628, such as the web-based interface shown in FIGS. 6a and 6b, a standalone application-based interface, or the like, that is supported by the operating system of the client device 108, through which the player may participate and/or interact with the gaming service.

The interface 628 provided to the player via the client 108 can be configured in a number of different ways to facilitate interactions between the player and the gaming service. As shown in FIG. 6a for instance, the interface 628 may be used to receive registration information from a new user so as to register the user with one or more gaming services and to store the player information in the database or memory 116 associated with the gaming servers 102. More particularly, the interface 628 may be used to gather information such as the player's name, mailing address, contact information, electronic mailing address, and the like. The registration interface 628 may also enable the player to establish a desired alias, username or login, as well as corresponding passwords or other login credentials.

### Client Interface—Gameplay

In addition, the interface 628 can be used to enable play of a wagering game or otherwise facilitate player participation. As noted above, the wagering game may be a game of chance, a contest, a social (i.e., “play-for-fun”) game, a sweepstake, or other gaming content provided by the gaming servers 102, as shown in FIG. 6b. For example, while displaying images, video, audio, and/or any other media pertaining to play of a wagering game, the interface 628 may also be configured to receive various inputs from the player during gameplay. Based on the type of client device 108 being used and the types of input devices 118 available to the player, for example, the player may provide game input using actions such as mouse-clicks, keystrokes, mouse gestures, finger or hand gestures, voice commands, and the like. Such player input is read by the client device 108 and used to determine the corresponding actions and/or selections that are desired by the player. The relevant actions and/or selections can then be communicated to the respective gaming servers 102 in a manner which enables the player to gain entry into contests or sweepstakes, advance through levels or stages of a game of chance, acquire cash-redeemable credits or virtual currency, rewards, points, and the like.

### Player Accounts

Player accounts may be used to store, track, and update information associated with registered players of the wagering game. Each registered player may have an associated player account. For example, a first player account may be associated with a first player, a second player account may be associated with a second player, and so on. Each player account may include account information associated with a respective registered player. In addition to the player information noted above, each player account may include additional information related to play of the wagering game, such as information indicative of an amount of money, virtual currency, or other assets attributed to the player associated with the player account. The assets may be configured for use in the wagering game or other games. For example, the player account may include a real credit balance indicative of real credits available for wagering in a casino-style wagering game, a virtual credit balance indicative of an amount of virtual credits available for wagering in a social/casual type wagering game, and/or other account information that tracks other assets or attributes that may be used in the casino, social/casual, or other type of wagering game. The player accounts may be stored on a remote server, such as the account server 106. Alternatively, the player accounts may be stored locally, such as on a gaming device 410, 510, stationary or portable PC, on-site server (e.g., a casino server), or other computational device 360.

### Loan Value

A loan value may be an amount of assets designated by a first player (or “lender”) for loaning to a second player (or “loan recipient”). For example, the account server 106 may be configured to allow the first player to access the first player account and designate a specified value held in that account to be the loan value to be transferred to another player account. The loan value may include real credits, bonus credits, or other assets having a cash value that may be wagered in a casino-style wagering game. In other embodiments, the loan value may have no direct monetary value. For example, the loan value may include virtual credits, a bonus game, a bonus mechanic, a bonus item, or other virtual attributes that may be wagered or otherwise used in a social game.

### Loan Conditions

One or more loan conditions may be associated with the loan value that may govern the lender/loan recipient relationship between the first and second players. In general, the loan conditions may be considered agreements between the first and second players regarding the loan transaction, the use of the loan in a wagering game, the shares of winning outcomes, and other parameters. To associate a loan condition with a loan value, the first player may interface with a computational device 360 provided on the gaming system 100. During this interface, the first player may be prompted to select one or more loan conditions that define various aspects of the lender/loan recipient relationship.

In some embodiments, the at least one loan condition may be a predetermined agreement as to how winning outcomes from wagers of the loan value will be split between the first and second players. For example, a first predetermined win share ratio may be selected that represents the relative shares of winnings of the first and second players. A win share ratio of 1:1, for example, may indicate that each of the first and second players will share equally in a winning outcome. Alternatively, a win share ratio of 1:2 may indicate that the first player will receive ⅓ of the winning outcome and the second player will receive ⅔ of the winning outcome. Conversely, a win share ratio of 2:1 may indicate that the first player will receive ⅔ of the winning outcome while the second player will receive ⅓ of the winning outcome. The foregoing win share ratios are merely exemplary, as the winning outcome may be split between the players using any desirable ratio, including providing a full share of the winning outcome to either of the first and second players.

In some implementations, the at least one loan condition may include multiple different win share ratios that are used at different times during play of the wagering game. For example, first and second predetermined win share ratios may be used, in which the first win share ratio is different from the second win share ratio. The first win share ratio may be used or otherwise associated with a first game mode while the second win share ratio may be used or otherwise associated with a second game mode. The first and second game modes may be associated with the same wagering game, such as where the first game mode comprises a normal game format and the second game mode comprises a bonus or progressive game format. Alternatively, the first game mode may be associated with a first wagering game and the second game mode may be associated with a second wagering game. In this alternative implementation, the loan value may be used in more than one wagering game, with different loan conditions applying to the different wagering games.

In other embodiments, the at least one loan condition may include a restriction on the use of the loan value. For example, the loan condition may be a loan expiration date that identifies a deadline by which the loan value may be used. Should the second player fail to use all or a portion of the loan value by the loan expiration date, the remaining unwagered amount of the loan value may be returned to the first player. The account server 106 may track the loan value in a separate loan value account associated with the second player and when the expiration date is reached, the account server 106 may execute a transfer of the remaining, unwagered amount of the loan value from the second player account to the first player account.

In some implementations, the at least one loan condition may restrict the type of wagering game on which the loan value may be used. For example, the at least one loan condition may specify one or more types of wagering games in which the loan value may be used. Examples of wagering game types include slots, blackjack, craps, roulette, sports wagering, horse race wagering, and social games. Additionally, or alternatively, the at least one loan condition may specify a particular game format, such as a blackjack game that has specific rules, or a slot machine that offers a progressive jackpot. Still further, the at least one loan condition may specify a particular wagering position, such as a specific seat at a particular blackjack table, or a specific machine located in a particular casino.

In some embodiments, the at least one loan condition may include a progressive jackpot threshold which must be met before the loan value may be used in the wagering game. For example, the at least one loan condition may specify a minimum progressive jackpot amount associated with the wagering game before the loan value may be wagered. Different minimum progressive jackpot amounts may be used for different types of progressive jackpots (i.e., stand-alone, local-area, or wide-area progressives), a minimum wager amount for the wagering game, or other factors.

In other embodiments, the at least one loan condition may include a selected time of day during which the first loan value may be wagered. For example, the first player may desire to be available to communicate with the second player during or shortly after the loan value is wagered. Accordingly, the first player may use a computational device 360 to interface with the gaming system 100, such as the account server 106, to enter a selected time of day during which the loan value may be wagered. The time of day may be a specific time, a specific range of times, or multiple specific ranges of times during which the loan value may be used. Furthermore, the specified time restriction may apply to a designated day or range of days, or may be applicable indefinitely.

In some embodiments, the at least one loan condition may include an agreement to periodically permit the first player to control operation of the wagering game in selected gameplay situations. For example, a predetermined gameplay threshold may be established which, when satisfied, will permit the first player to operate the wagering game for a specific period of time. In one implementation, the predetermined gameplay threshold may be when a bonus game format of the wagering game is triggered, after which the first player is given control of the wagering game for all or a portion of the bonus game session. Control of the wagering game may revert back to the second player once the bonus game session, or portion thereof, is complete. In another implementation, where multiple lenders have each transferred a loan value to a loan recipient, each lender may receive control of a separate, respective bonus game. Alternatively, when multiple lenders are active, control of the bonus game may be alternated among the lending players.

### Selection of the Loan Recipient

The first player (i.e. the lender) may select the second player (i.e., the loan recipient) in a variety of different manners. In general, the first player may interface with a computational device 360 provided on the gaming system 100, such as the account server 106, to identify the second player as the loan recipient.

In some embodiments, the selection may be based on a pre-existing relationship between the first and second players. For example, a plurality of pre-existing social contacts may be associated with the first player account, and the first player may identify one of the pre-existing social contacts as the loan recipient.

In other embodiments, the first player may not have a pre-existing relationship with the second player prior to the loan transaction. Instead, the second player may be selected based on a common interest with the first player.

In some implementations of the interest-based selection of the loan recipient, one or more statistics of a player may be tracked and displayed by the gaming system 100. For example, one or more of a speed of play, wager amount, recent win amount, player location, or other statistic may be tracked for a selected group of wagering game players and displayed to the first player via the gaming system 100. The first player may select one player based on the displayed statistics to designate as the loan recipient. To assist with the selection, the first player may identify a hierarchy of statistics and/or desired ranges of statistics to filter the number of players that are displayed. Alternatively, the gaming system 100 may generate a group of recommended potential loan recipients based on the player statistics. The recommended players may be identified using a template of desired statistics and/or ranges of values within those statistics that is selected by the first player. Alternatively, the template may be generated based on past play of the first player.

In other implementations of the interest-based selection of the loan recipient, one or more gameplay characteristics associated with a plurality of wagering positions may be determined and displayed by the gaming system 100. For purposes of the present detailed description, the term “wagering position” includes any point through which a wagering game may be accessed, such as a land-based slot machine, a betting spot on a casino table game (i.e., blackjack table, craps table, etc.), and a home computer or mobile device accessing an on-line wagering game. The gaming system 100 may determine one or more gameplay characteristics associated with each wagering position. The gameplay characteristics may relate to the wagering game itself, such as the type of wagering game format (i.e., slots, craps, blackjack, social game, etc.), a minimum or maximum wager amount, wagering game mechanics (i.e., mechanical or virtual slot reels, availability of a bonus game, etc.). Additionally or alternatively, the gameplay characteristics may relate to the environment in which the wagering position is provided, such as a particular city, a particular casino, a particular location on a casino floor, or a particular website. Still further, the gameplay characteristics may relate to a current status of the machine, such as a current amount of a stand-alone, local-area, or wide-area progressive jackpot.

In some embodiments, the gaming system 100 may be configured to permit the lender to change loan recipients. That is, prior to the second player wagering all of the loan value, the first player may recall the loan value and designate another loan recipient using the same or different loan conditions.

Still further, the gaming system 100 may be configured to alert the first player to the wagering activity of a previously identified player. Based on past loan transactions or player criteria selected by the first player, the gaming system 100 may identify potential loan recipients that may be of interest to the first player. When a potential loan recipient accesses the wagering game, the gaming system 100 may prompt the first player to indicate whether the first player would like to initiate a loan to the potential loan recipient.

Acceptance of Loan Condition and Transfer of Loan Value between Player Accounts

To accept the at least one loan condition, the second player may interface with a computational device 360 provided on the gaming system 100, such as the account server 106. During this interface, the second player may be prompted to review information associated with the loan value and loan condition, such as an amount of the loan value and the terms of the at least one loan condition. As noted above, the loan value may be any type of asset (i.e., cash value credit, virtual credit, virtual attribute, etc.). The second player may further be prompted to indicate whether the second player agrees to the at least one loan condition by inputting whether or not the at least one loan condition is accepted.

Once the second player accepts the at least one loan condition, the account server 106 may then transfer the loan value from the first player to the second player. The transfer of the loan value may be executed by the account server 106 by updating the respective account balances of the first and second player accounts to reflect the loan transaction. For example, if the loan value is $50 cash, the account balance of the first player may be debited by $50 and the account balance of the second player may be credited by $50. The loan value of $50 may be credited to a separate loaned value account associated with the second player account to permit tracking of the loan value separate from the other assets in the second player account.

### Wagering of Loan Value

The gaming system 100 may require the at least one loan condition to be satisfied before the second player may wager the loan value in the wagering game. The manner in which satisfaction of the loan condition is confirmed may vary, depending on the nature of the loan condition. In some implementations, the loan condition may be confirmed immediately upon acceptance by the second player. For example, loan conditions that simply establish a predetermined win share ratio may be determined to be present when the second player account is determined to have accepted the loan condition. Other loan conditions may require additional tracking by the gaming system 100 to determine whether the loan condition is met. For example, loan conditions that set a loan expiration date or a selected time of day may require confirmation that the attempted wager of the loan amount is timely. Still other loan conditions may require the second player to conform to predetermined gameplay criteria before the loan value may be wagered. For example, the loan condition may identify a specific type of casino game (i.e., slots, craps, blackjack, video poker, etc), a wagering game having specific attributes (i.e., mechanical reels, progressive jackpot minimum, minimum wager denomination, etc.), a specific type of social game, or other gameplay criteria that the second player must conform to in order to access the loan value.

When the at least one loan condition is confirmed as being present, the second player may wager the loan value in the wagering game. The one or more gaming servers 102 may discern whether a wager by the second player was made using the loan value or other assets. In some implementations, the first and/or second player may select when to wager the loan value using the inputs 118 of a client device 108. For example, the display 120 may show a “loan play” option that may be selected by the first player. The one or more gaming servers 102 may be configured to allow the first player to select the loan play option, thereby allowing or requiring the loan value to be wagered. Alternatively, the second player may be presented with the loan play option, thereby allowing the second player to control when the loan value is wagered. Still further, both the first and second players may be presented with the loan play option, and the loan value may be wagered only when both players activate the loan play option. The one or more gaming servers 102 may determine whether the loan play option is selected to determine whether the loan value is to be wagered.

In other implementations, the gaming system 100 may select when the loan value is used as the wager. For example, the one or more gaming servers 102 may be configured to randomly select when the loan value is wagered while the second player plays a session on the wagering game. After the second player selects a wager amount, and prior to the draw, the one or more gaming servers 102 may select whether the wager amount is to be debited from the loaned value account balance. Determining when the loan value is wagered may be based on a random number generator, a wheel spin, or other process for randomly selecting when the loan value is wagered in the wagering game.

Alternatively, the one or more gaming servers 102 may be configured to apply the loan value at a predetermined period during a play session. For example, the one or more gaming servers 102 may require all loan value associated with the second player account to be used before allowing the second player to wager from other balances stored on the account. Additionally or alternatively, the one or more gaming servers 102 may periodically select to wager portions of the loan value at regular or random intervals throughout the play session.

The wager made by the second player in the wagering game may be an aggregate wager, in which other assets in addition to the loan value are at risk in the wagering game. In some embodiments, a separate wager value may be associated with the second player account, and the aggregate wager may include both the loan value and the separate wager value. For example, the aggregate wager may be for a total of 100 credits, which may include a loan value of 50 credits and a separate wager value (taken from pre-existing assets of the second player) of 50 credits. The separate wager value may be assets contributed by the second player, or may be other loan values from other players.

The wager made by the second player in the wagering game may be attributed solely to the second player account. That is, when the loan value and any separate wager value are wagered as an aggregate wager, the total value of the aggregate wager may be debited directly from the second player account. Consequently, the second player may receive all or portions of any out-of-game or in-game benefits attributable to the wager. An out-of-game benefit may include points in a loyalty program, entries in a sweepstakes, comp credits, or other benefits provided outside of the wagering game. An in-game benefit may include any advantage the game may provide for maximum or high-level wager levels, such as qualification for a progressive jackpot, qualification for a bonus game, awarding of a bonus game mechanic, or other benefit provided directly within the wagering game. Even when the players have agreed to share the winnings (as described in greater detail below), the second player may receive all or a disproportionate amount of the benefits associated with the aggregate wager.

The first and second players may determine how in-game and out-of-game benefits may be divided. In some implementations, all of the in-game and out-of-game benefits may be awarded to the second player as incentive to accept the loan offer by the first player. In other implementations, the first and second players may agree on predetermined shares of the in-game and out-of-game benefits. For example, the players may agree to split the benefits in shares substantially proportional to the respective amounts of the wager contributed by each player. Alternatively, the players may agree to award all of the out-of game benefits to one player, such as the second player, while splitting the in-game benefits. Still further, the players may agree divide in-game benefits based on a mode of the wagering game, such as awarding in-game benefits associated with a normal game format to one of the players and in-game benefits associated with a bonus game format to the other of the players.

### Loan Win Amount

A loan win amount may be determined based on the outcome of the wagering game when the loan value is wagered. Accordingly, the loan win amount is indicative of the amount of assets accrued from winning outcomes of the wagering game when the loan value is wagered. The loan win amount may be a monetary value or a virtual value that is not redeemable for cash. The one or more gaming servers 102 may communicate with the account server 106 to track the loan win amount.

In implementations where the wagering game accepts wagers having real cash value, the loan win amount may be based on a payout percentage associated with the wagering game. The payout percentage is the theoretical percentage of coin in that the wagering game will pay back in winning game outcomes, and may alternatively be expressed as the expected value of the game. In slot games, the payout percentage is reflected in one or more payout tables that define predetermined payouts for specific game outcomes. A slot game may have more than one payout table, such as a base game payout table, a bonus game payout table, and a progressive game payout table. The amounts of the winning outcomes and the theoretical probability with which those outcomes will occur determine the overall payout percentage of the slot game.

Allocating Loan Win Amount between Players

The loan win amount resulting from a successful game outcome based on a wager of the loan value may be allocated between the first and second players according to various allocation arrangements. As noted above, the first and second players may agree to a predetermined win share ratio as a loan condition. The account server 106 and/or game servers 102 may be configured to apply a specific allocation arrangement to the loan win amount.

### Notification of Outcome to Lender

The gaming system 100 may be configured to generate a notification to the first player regarding the wagering of the loan value. The notification may be provided in one or more formats, including a live video feed, a graphical reproduction based on data sent to an on-line server, a text message, and an email. When sent in text form (i.e., text message, email, etc.), the notification may include information identifying at least one of the name of the second player, the type of wagering game played, the city and/or casino in which the wager was made, and the outcome. The notification may be sent at predetermined times, such as after each outcome of a wager with the loan value, after the entire loan value has been wagered, when a threshold win or loss amount is reached, when a threshold amount of the loan value has been wagered, or at any other time specified by the gaming system 100 or first player. The notification may be sent to any device suitable for receiving the notification, such as a mobile phone, smart phone, home computer, wagering machine terminal, or other device capable of receiving and displaying a video feed or text-based notification. The format, level of detail, timing, and delivery device for the notification may be set by the gaming system 100 or selected by the first player.

### Algorithms/Methods for Managing Loaning in a Wagering Game

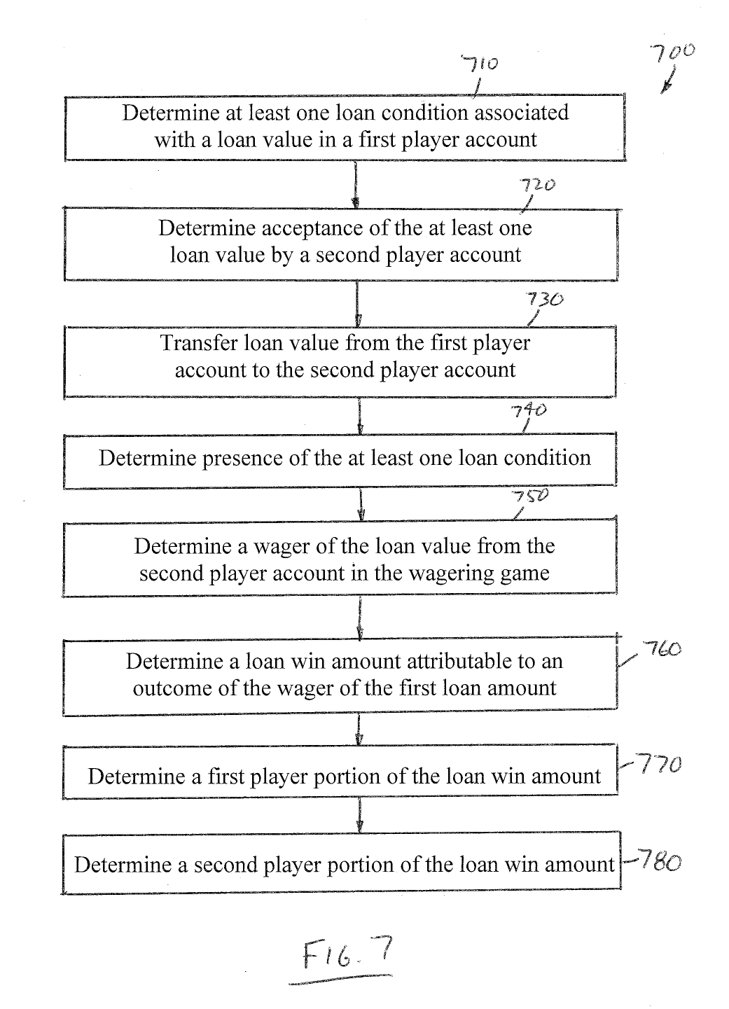

Turning to FIG. 7, an exemplary embodiment of an algorithm or method is provided by which one or more of the processors of the gaming system 100 may be configured to operate. The processors may include any one or more of a controller, a microcontroller, a microprocessor, a central processing unit (CPU), a field programmable gate array (FPGA), a digital signal processor (DSP), or any other suitable means for electronically controlling functionality of the gaming servers 102, community servers 104, account servers 106, and/or clients 108. Instructions for operating the one or more processors may be provided within the memory 114, such as a read only memory (ROM), random access memory (RAM), magnetic disk storage media, optical storage media, flash memory, or the like, that is locally or remotely disposed in communication with the processors.

A method 700 of managing loan transactions in a wagering game is illustrated in FIG. 7. The loan transaction may take place in a wagering game, which may be a wagering game accessible from a real world or on-line casino, a social game (i.e., a “play-for-fun” game), or other type of game content. The wagering game may be accessed by a computational device 360, such as the free-standing gaming machine 410, the handheld gaming machine 510, a stationary or portable PC, a mobile device, or other computing device.

At block 710, the processors of the gaming servers 102 and/or account servers 106 may be configured to determine at least one loan condition associated with a loan value in a first player account. More specifically, the processors may supply data which can be communicated to and downloaded by the client devices 108 over one or more networks 110 to generate and display a first player account interface using, for example, a web browser, a standalone application or program, or the like, within the client devices 108. Through the first player account interface, and using one or more input devices 118 of the client 108, a first player may access an associated first player account, select an asset from one or more account balances to be designated as the loan value, and specify at least one loan condition that may govern the availability and use of the loan value. Any or all of the information submitted by the first player may be communicated back to the gaming servers 102 and account server 106 and stored within a database or memory associated therewith.

At block 720, the processors of the gaming server 102 and/or account server 106 may be configured to determine an acceptance of the loan condition by a second player account. More specifically, the processors may supply data which may be communicated to and downloaded by the client devices 108 over the one or more networks 110 to generate and display a second player account interface using, for example, a web browser, a standalone application or program, or the like, within the client devices 108. Through the second player account interface, and using one or more input devices 118 of the client 108, the second player may access an associated second player account, review information regarding the loan value and the at least one loan condition, and input an acceptance of the terms of the at least one loan condition. Any or all of the information submitted by the second player may be communicated back to the gaming servers 102 and account server 106 and stored within a database or memory associated therewith.

Upon confirmation that the second player has accepted the at least one loan condition, the processors of the gaming server 102 and/or account server 106 may be configured to transfer the loan value from the first player account to the second player account, as shown at block 730. In particular, the servers may debit an account balance of the first player account by the loan value amount, and credit an account balance of the second player account with the loan value amount.

At block 740, the processors of the gaming servers 102 and/or account server 106 may be configured to determine that the loan condition is present. More specifically, the clients 108 may provide data regarding the acceptance of the at least one loan condition and/or the specifics of the wagering activity by the second player to the processors, which may compare that information to stored data providing the specifics of the at least one loan condition.

When the at least one loan condition is determined to be present, the processors of the gaming system 100 may determine a wager of the loan value in a wagering game at block 750. More specifically, the processors may present the wagering game on a display 120 of the client 108 and allow the second player to select when to wager the loan value. Alternatively, the processors may be configured to select when the loan value will be wagered.

When the loan value is wagered in the wagering game, the processors of the gaming servers 102 and/or account server 106 may be configured to determine a loan win amount that is attributable to an outcome of that wager, as shown at block 760. In particular, the processors may be configured to determine the loan win amount based on a payout percentage associated with the wagering game.

The processors of the gaming servers 102 and/or account server 106 may be configured to determine how the loan win amount is shared by the first and second players, as shown at blocks 770 and 780. More specifically, the processors may be configured to allocate shares of the loan win amount according to a win share ratio or other arrangement previously agreed upon by the first and second players. The respective first and second player win shares may be predetermined and stored at the gaming servers 102 and/or account server 106. The processors may apply the respective player win shares to the loan win amount and communicate first and second player shares to the account server 106. The processor of the account server 106 may be configured to update the loaned balance, real credit balance, virtual credit balance, or other asset balance associated with each player account to reflect the respective share of the loan win amount to be credited.

The wagering game may have any one of various game formats. Examples of game formats may include a cash value wagering game format, in which a monetary value may be wagered, and a virtual value wagering game format, in which the wagering game may be played for free or with virtual currency (i.e., a “play-for-fun” game format commonly provided on social websites). Additionally, the wagering game may be conducted at any one of various game venues. Examples of game venues may include a land-based casino, an on-line casino, a social website accessed via a home computer, and an application on a mobile device. Still further, the players involved in the loan transaction may be located at any one of the game venues. That is, the first player that lends the loan value may be located at a land-based casino, at home on an on-line casino or social website, or on a mobile device. The second player that receives the loan may similarly be at a land-based casino, at home on an on-line casino or social website, or on a mobile device. The first and second players may be located in the same venue location, the same type of location, or different venues.

As noted above, the disclosure of “a” first player and “a” second player is intended to encompass “at least one” first player and “at least one” second player, respectively. That is, in certain embodiments, the gaming system 100 may be configured to permit a plurality of lenders to each transfer a loan value to a single or multiple loan recipients, and/or a plurality of loan recipients to receive a loan value from a single or multiple lenders. For example, a third player account may have a second loan value having the at least one loan condition. Upon acceptance of the loan condition, both the first and second loan values may be transferred to the third player account. The wager made by the second player may be an aggregate of portions of at least the first and second loan values, and the loan win amount may further include a third player portion to be credited to the third player account. The loan win amount may be split among the players in shares proportional to their respective contributions to the aggregate wager, or in any other manner predetermined by the players. In some embodiments, and incentive to offer loan values may be provided in which the first player to offer a loan value may receive an additional portion of the loan win amount.

FIGS. 6-7, described by way of example above, represent algorithms that correspond to at least some instructions executed by one of the computational devices illustrated in FIGS. 1-5 to perform the above-described functions associated with the disclosed concepts. Each of these embodiments and obvious variations thereof are contemplated as falling within the spirit and scope of the following claims. Moreover, the present concepts expressly include any and all combinations and sub-combinations of the preceding elements and aspects.

What is claimed is:

1. A computer-implemented method of managing a loan transaction in a wagering game, comprising:
determining at least one loan condition associated with a first loan value in a first player account;
in response to determining an acceptance of the at least one loan condition by a second player account, transferring the first loan value from the first player account to the second player account;
in response to determining that the at least one loan condition is present, determining a wager of the first loan value from the second player account in the wagering game;
determining a loan win amount attributable to an outcome of the wager of the first loan value;
determining a first player portion of the loan win amount; and
determining a second player portion of the loan win amount.

2. The computer-implemented method of claim 1, in which the at least one loan condition comprises a first predetermined win share ratio of the first player portion of the loan win amount to the second player portion of the loan win amount.

3. The computer-implemented method of claim 2, in which the at least one loan condition further comprises a second predetermined win share ratio different from the first predetermined win share ratio, and in which the first predetermined win share ratio is associated with a first game mode and the second predetermined win share ratio is associated with a second game mode.

4. The computer-implemented method of claim 3, in which the first and second game modes are associated with the wagering game.

5. The computer-implemented method of claim 4, in which the first game mode comprises a normal game format and the second game mode comprises a bonus game format.

6. The computer-implemented method of claim 1, in which the at least one loan condition comprises a loan expiration date, and in which the method further comprises:
in response to determining that the loan expiration date is met, determining an unwagered amount of the first loan value and transferring the unwagered amount of the first loan value from the second player account to the first player account.

7. The computer-implemented method of claim 1, further comprising, prior to determining the acceptance of the first loan value under the at least one loan condition, determining a selection of the second player account by the first player account.

8. The computer-implemented method of claim 7, in which a plurality of pre-existing social contacts is associated with the first player account, and in which determining the selection of the second player account comprises determining an identification of the second player account from the plurality of pre-existing social contacts.

9. The computer-implemented method of claim 7, further comprising determining a group of player accounts associated with the wagering game and displaying at least one player statistic for each player account in the group of player accounts, in which determining the selection of the second player account comprises determining an identification of the second player account from the group of player accounts.

10. The computer-implemented method of claim 9, in which the at least one player statistic is selected from a group of player statistics including speed of play, wager amount, recent win amount, and player location.

11. The computer-implemented method of claim 7, further comprising:
determining a group of wagering positions associated with the wagering game; and
displaying at least one gameplay characteristic associated with each wagering position;
in which determining the selection of the second player account comprises determining an identification of a specific wagering position, from the group of wagering positions, associated with the second player account.

12. The computer-implemented method of claim 1, in which the at least one loan condition comprises a predetermined gameplay threshold, the method further comprising transferring control of the wagering game to the first player account in response to determining that the predetermined gameplay threshold is met, wherein the predetermined gameplay threshold comprises a triggering of a bonus game format of the wagering game.

13. The computer-implemented method of claim 1, further comprising:
determining a second loan value in a third player account, the second loan value having the at least one loan condition;
transferring the second loan value from the third player account to the second player account in response to the acceptance of the at least one loan condition by the second player account;
wherein the wager comprises an aggregate of at least the first loan value and the second loan value; and
wherein a third player portion of the loan win amount is determined.

14. The computer-implemented method of claim 1, in which the wager comprises an aggregate wager including at least the first loan value and a separate wager value associated with the second player account, wherein the aggregate wager is debited directly from the second player account.

15. A gaming system comprising a processor, a memory, in communication with the processor, a display, and an input/output circuit, the processor being physically configured according to computer executable instructions for managing loaning in a primary game, the computer executable instructions comprising instructions for:
determining at least one loan condition associated with a first loan value in a first player account;
in response to determining an acceptance of the at least one loan condition by a second player account, transferring the first loan value from the first player account to the second player account;
in response to determining that the at least one loan condition is present, determining a wager of the first loan value from the second player account in the wagering game;
determining a loan win amount attributable to an outcome of the wager of the first loan value;
determining a first player portion of the loan win amount; and
determining a second player portion of the loan win amount.

16. The gaming system of claim 15, in which the at least one loan condition comprises a first predetermined win share ratio of the first player portion of the loan win amount to the second player portion of the loan win amount.

17. The gaming system of claim 16, in which the at least one loan condition further comprises a second predetermined win share ratio different from the first predetermined win share ratio, and in which the first predetermined win share ratio is associated with a first game mode and the second predetermined win share ratio is associated with a second game mode.

18. A tangible machine-readable storage media including instructions which, when executed by one or more processors, cause the one or more processors to perform operations comprising:
determining at least one loan condition associated with a first loan value in a first player account;
in response to determining an acceptance of the at least one loan condition by a second player account, transferring the first loan value from the first player account to the second player account;
in response to determining that the at least one loan condition is present, determining a wager of the first loan value from the second player account in the wagering game;
determining a loan win amount attributable to an outcome of the wager of the first loan value;
determining a first player portion of the loan win amount; and
determining a second player portion of the loan win amount.

19. The tangible machine-readable storage media of claim 18, in which the at least one loan condition comprises a first predetermined win share ratio of the first player portion of the loan win amount to the second player portion of the loan win amount.

20. The tangible machine-readable storage media of claim 19, in which the at least one loan condition further comprises a second predetermined win share ratio different from the first predetermined win share ratio, and in which the first predetermined win share ratio is associated with a first game mode and the second predetermined win share ratio is associated with a second game mode.
